(19) United States
(12) Patent Application Publication
(10) Pub. No.: US 2022/0142366 A1
(43) Pub. Date: May 12, 2022

(54) CARRIAGE FOR A DRAWER PULL-OUT GUIDE

(71) Applicant: Julius Blum GmbH, Hoechst (AT)

(72) Inventors: Pascal BERCHTOLD, Alberschwende (AT); Daniel BOCH, Opfenbach (DE); Matthias JAEGER, Dornbirn (AT); Stephanie SCHUETZ, Bregenz (AT); Manuel PETERMAIR, Bregenz (AT)

(21) Appl. No.: 17/581,171

(22) Filed: Jan. 21, 2022

Related U.S. Application Data
(63) Continuation of application No. PCT/AT2020/060256, filed on Jun. 29, 2020.

(30) Foreign Application Priority Data
Jul. 25, 2019 (AT) A 50677/2019

(51) Int. Cl. A47B 88/487

(52) U.S. Cl. CPC A47B 88/487; A47B 2210/0037

(57) ABSTRACT

A running carriage for a drawer pull-out guide, the running carriage includes a base body and a plurality of load-transmitting rolling bodies arranged in or on the base body. The load-transmitting rolling bodies are rotationally supported on the base body about a rotational axis orientated in a first direction. The running carriage further includes a first roller and a second roller rotationally supported on the base body about a rotational axis orientated in a second direction. The rotational axis oriented in the second direction extends transversely to the rotational axis orientated in the first direction, and the first roller has a larger diameter than the second roller.

### BACKGROUND OF THE INVENTION

The present invention relates to a running carriage for a drawer pull-out guide. The running carriage comprises a base body and a plurality of load-transmitting rolling bodies arranged in or on the base body, the load-transmitting rolling bodies being rotationally supported on the base body about a rotational axis orientated in first direction. The running carriage further comprises a first roller and at least one second roller rotationally supported on the base body about a rotational axis orientated in a second direction, the rotational axis oriented in the second direction extending transversely to the rotational axis orientated in the first direction.

Moreover, the invention concerns a drawer pull-out guide comprising at least one running carriage of the type to be described.

Moreover, the invention relates to an arrangement comprising a first drawer pull-out guide and a second drawer pull-out guide of the type to be described, the first drawer pull-out guide being configured to be arranged on a first side of a drawer and the second drawer pull-out guide being configured to be arranged on a second side of the drawer.

Finally, the invention relates to a drawer comprising at least one of such a drawer pull-pull-out guide or an arrangement of the aforementioned type.

A generic running carriage is shown, for example, in FIG. 3 of the WO 2017/106889 A2 reference. The running carriage 24 includes rolling bodies 25, 26, 27, and the load-transmitting rolling bodies 26 are rotatable about a horizontally extending rotational axis, and the rolling bodies 26, 27 in the form of rollers are rotatable about a vertically extending rotational axis.

With drawer pull-out guides, misalignments of the running carriage may arise, leading to the drawer staying open during normal use. A misalignment of the running carriage denotes an incorrect positioning of the running carriage, the incorrect positioning building up over an opening movement or over a closing movement and being determined by the built-up difference in relation to the correct initial position. A misalignment of the running carriage can build up, in particular, due to slippage or due to elasticity in the rolling or running system during the operating movement of the drawer pull-out guide. As from a certain number of movements, the running carriage can eventually depart so far from its target position that the running carriage hits against an end stop in the rail system, even before the drawer has reached the fully closed-end position and/or the fully open-end position relative to the furniture carcass.

The rollers of the running carriage are usually guided with a small clearance relative to the lateral running limbs of the guide rails of the drawer pull-out guide. In this way, manufacturing tolerances can be compensated for, and a jamming of the rollers with the lateral running limbs of the guide rails can be prevented. The occurring clearance between the rollers of the running carriage and the associated running limbs of the guide rails, with respect to a misalignment of the running carriage, is hardly noticeable when the drawer is heavily loaded, because the rollers of the running carriage are pressed against the guide rails by the load of the drawer. Due to the contact between the rollers and the guide rails, the running carriage can also entrained therewith, so that either no misalignment or only a slight misalignment of the running carriage is present.

However, when the drawer is not loaded or only slightly loaded, it is possible that the rollers are at least temporarily spaced from the associated running limbs of the guide rails. Due to the lacking contact between the rollers of the running carriage and the guide rails of the drawer pull-out guide, the running carriage will not further be moved upon a movement of the drawer pull-out guide. As a result, the running carriage deviates from its target position. When the drawer is repeatedly opened only to a half or only to a third, the running carriage abuts against an end stop of the drawer pull-out guide, even before the drawer reaches the fully open position. In order to fully open the drawer, the extendable guide rail must be drawn over the running carriage by applying a manual pulling force, leading to an increased friction and to increased opening forces of the drawer pull-out guide.

### SUMMARY OF THE INVENTION

It is an object of the present invention to propose a running carriage of the type mentioned in the introductory part, thereby avoiding the above-discussed drawbacks.

According to the invention, the first roller has a larger diameter than the second roller.

It is to be noted that “load-transmitting rolling bodies” according to the aspect of the present invention are to be understood as those rolling bodies which, in fact, bear a weight force of the drawer and which are rotatable about a, preferably horizontally extending, rotational axis when the drawer pull-out guide is duly installed.

On the contrary, “rollers” according to the aspect of the present invention are denoted as those rollers of the running carriage that have a rotational axis which, when the drawer pull-out guide is duly installed, deviate from a horizontal position. It is preferable that the rollers of the running carriage are rotatable about a vertically extending rotational axis.

In other words, at least one roller of the running carriage, the roller having a rotational axis deviating from a horizontal position when the drawer pull-out guide is duly installed, has a larger diameter than a second roller of the running carriage. The first roller having the larger diameter, in a mounted condition of the running carriage, bears against at least one running limb of the drawer pull-out guide without clearance. Therefore, the running carriage can always be coupled to a movement of an extendable guide rail upon a relative movement of the drawer pull-out guide. Accordingly, the first roller of the running carriage is configured to permanently bear against a running limb of an extendable guide rail without clearance. As a result, the running carriage always adopts a correct position in relation to the guide rails of the drawer pull-out guide.

Preferably, the running carriage includes precisely one first roller having a larger diameter. In this way, the frictional resistance of the drawer pull-out guide can be held on a low level.

At least one second roller of the running carriage has a smaller diameter in relation of the first roller of the running carriage, and the second roller is guided with a distance to the running limb of the drawer pull-out guide upon a relative movement of the drawer pull-out guide. Of course, the running carriage may also include two or a plurality of second rollers having a smaller diameter in relation to the diameter of the first roller.

Preferably, the rotational axis orientated in the first direction, in a mounting position of the running carriage, extends substantially horizontally, and/or that the rotational axis orientated in the second direction, in a mounting position of the running carriage, extends substantially vertically.

According to an embodiment, the first roller and the second roller are made of a different material. Thereby, the first roller consists of a plastic material and the second roller consists of metal. Alternatively, it is possible that the at least two rollers of the running carriage consist of different types of plastic.

The first roller having a larger diameter in relation to the second roller can be formed by a softer, in particular elastic, material than the second roller.

According to an embodiment, the first roller is configured as a two-component roller. The two-component roller can include an inner core and an outer shell separate from the core. Preferably, the shell and the core are formed by a different material or by different types of plastic.

The first roller and the second roller can have a different modulus of elasticity and/or a different friction coefficient.

According to an embodiment, the at least two rollers of the running carriage are each configured rotationally symmetrical, and the first roller and the second roller—apart from the different configuration in diameter—can have the same or a different geometry.

At least one roller of the running carriage, preferably the first roller, can include an elastic material, preferably silicone material. Due to the elastic properties of the first roller, the first roller can bear without clearance with a sufficient holding force against at least one running limb of an extendable guide rail, thereby transmitting a movement of the guide rail to the running carriage.

According to an embodiment, the rolling bodies and/or the first roller and/or the second roller has or have a cylindrical form. The configuration of cylindrical rolling bodies and cylindrical rollers has the advantage to bear against the guide rails of the drawer pull-out guide with a line contact. Therefore, the loading capacity of the drawer pull-out guide can be increased on the one hand and the lateral stability of the running carriage and the guide rails relative to one another can be improved on the other hand.

According to an embodiment, the first roller has a diameter between 3 mm and 5 mm, and/or the second roller has a diameter between 2 mm and 4 mm.

### BRIEF DESCRIPTION OF THE DRAWINGS

Further details and advantages of the present invention result from the following description of figures.

FIG. 1a, 1b show perspective views of an item of furniture comprising a drawer and a drawer-pull-out guide for displaceably supporting the drawer,

FIG. 2a, 2b show the drawer pull-out guide in two different vertical cross-sectional views,

FIG. 3a, 3b show a perspective view of a running carriage and an enlarged detail view thereof,

FIG. 4a, 4b show the drawer-pull-out guide in a cross-sectional view and an enlarged detail view thereof.

### DETAILED DESCRIPTION OF THE INVENTION

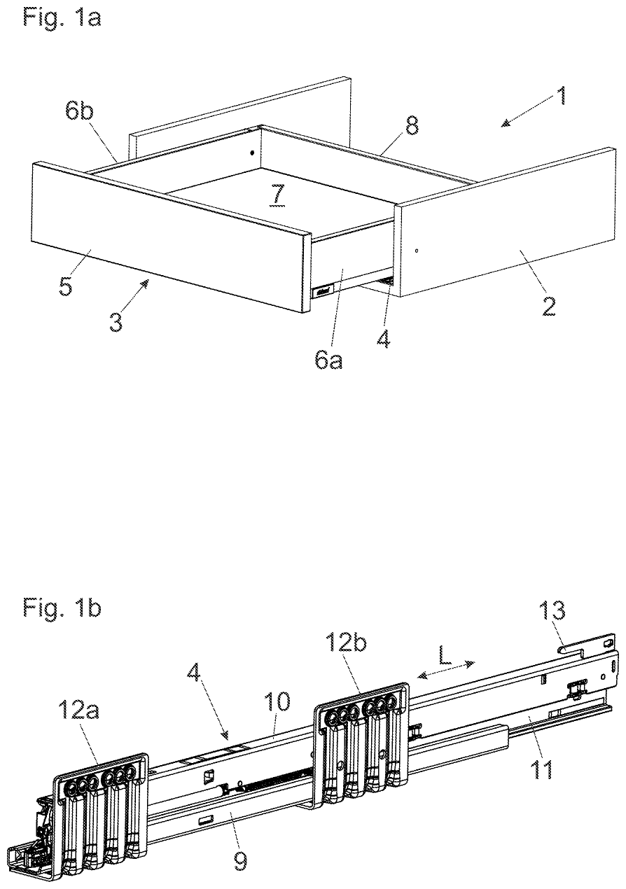

FIG. 1a shows a perspective view of an item of furniture 1 comprising a furniture carcass 2 and a drawer 3 displaceable relative to the furniture carcass 2. The drawer 3 is displaceably supported relative to the furniture carcass 2 by drawer pull-out guides 4. The drawer 3 includes a front panel 5, sidewalls 6a, 6b in the form of hollow-chamber profiles, a drawer bottom 7 and a rear wall 8.

FIG. 1b shows a drawer pull-out guide 4 in a perspective view. The drawer pull-out guide 4 includes a first guide rail 9 configured to be fixed to the furniture carcass 2 via a front fastening portion 12a and a rear fastening portion 12b. Moreover, the drawer pull-out guide 4 includes further guide rails 10, 11 displaceably supported relative to the first guide rail 9. A second guide rail 10 of the drawer pull-out guide 4 is connected or can be releasably connected to the drawer 3. For realizing a full extension of the drawer 3 in relation to the furniture carcass 2, a third guide rail 11 may optionally be provided, the third guide rail 11 being displaceable supported between the first guide rail 9 and the second guide rail 10. A hook 13 is arranged on the rear end of the second guide rail 10, the hook 13 being spaced from an upper side of the second guide rail 10 and extending in a longitudinal direction (L) of the drawer pull-out guide 4. In a mounted condition of the drawer 3, the hook 13 engages into a corresponding opening of the drawer 3 so as to stabilize the rear end region of the drawer 3 in a direction extending transversely to the longitudinal direction (L).

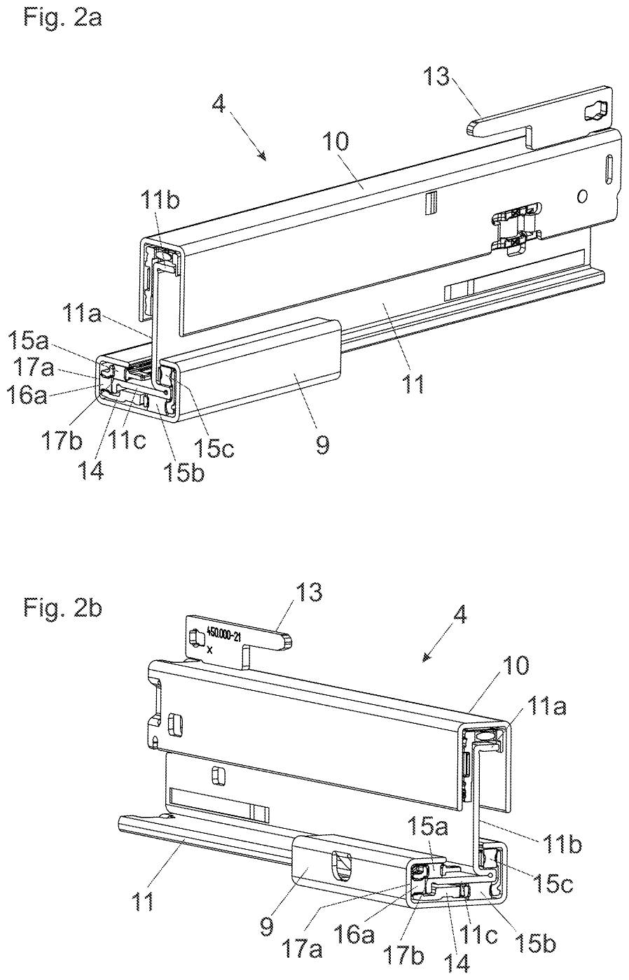

FIG. 2a shows the drawer pull-out guide 4 in a first vertical cross-sectional view. The drawer pull-out guide 4 includes the first guide rail 9 configured to be fixed to the furniture carcass 2, the second guide rail 10 configured to be fixed to the drawer 3, and the third guide rail 11 displaceably supported between the first guide rail 9 and the second guide rail 10. According to an embodiment, the first guide rail 9 can have a C-shaped cross-section. The second guide rail 10, in the shown figure, includes a U-shaped cross-section, whereas the third guide rail 11 includes a, preferably vertically extending, side limb 11 a and two, preferably horizontally extending, transverse limbs 11b, 11c mutually spaced from one another in a height direction.

At least one running carriage 14 is displaceably supported between the first guide rail 9 and the third guide rail 11. The running carriage 14 includes a plurality of load-transmitting rolling bodies 15a, 15b, 15c, 15d rotationally supported about a, preferably horizontally extending, rotational axis (X) orientated in a first direction. Moreover, the running carriage 14 includes at least two rollers 16a, 16b separate from the rolling bodies 15a, 15b, 15c, 15d. The at least two rollers 16a, 16b are rotationally supported about a, preferably vertically extending, rotational axis (Y) orientated in a second direction, the second direction extending transversely, preferably perpendicularly, to the first direction. The rollers 16a, 16b of the running carriage 14 are movably supported along a first running limb 17a of the first guide rail 9, and along a second running limb 17b of the third guide rail 11. It can be preferably provided that the first running limb 17a of the first guide rail 9 and the second running limb 17b of the third guide rail 11 extend substantially parallel to one another. The diameter of the first roller 16a is chosen such that the first roller 16a bears without clearance both against the first running limb 17a of the first guide rail 9 and against the second running limb 17b of the third guide rail 11. In this way, it can be ensured that the running carriage 14, upon a relative movement of the guide rails 9, 10, 11 to one another, can be permanently coupled to a movement of an extendable guide rail 10, 11 and, therefore, can always adopt a defined target position in relation to the guide rails 9, 10, 11.

FIG. 2b shows the drawer pull-out guide 4 according to FIG. 2a in a second cross-sectional view.

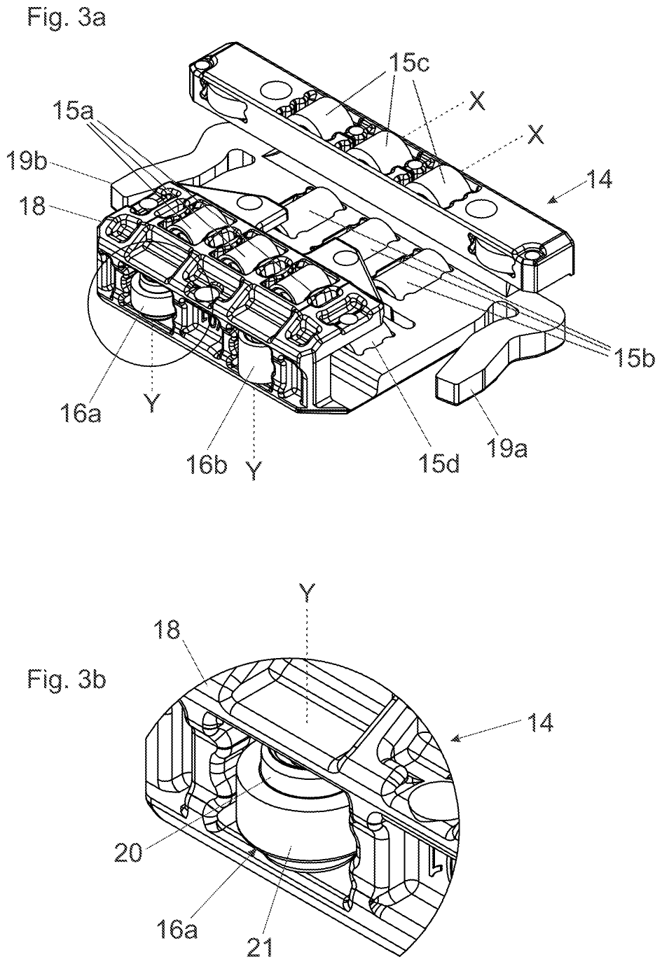

FIG. 3a shows an embodiment of a running carriage 14 comprising a base body 18 and a plurality of load-transmitting rolling bodies 15a, 15b, 15c, 15d supported in or on the base body 18, the load-transmitting rolling bodies 15a, 15b, 15c, 15d being rotationally supported about a rotational axis (X) orientated in a first direction. In the shown figure, a plurality of rolling bodies 15a, 15b, 15c, 15d is provided, the rolling bodies 15a, 15b, 15c, 15d being spaced from one another in a longitudinal direction of the running carriage 14. The rolling bodies 15a, 15b are arranged in a same (first) running plane and are arranged laterally offset to one another in a view onto a plane extending perpendicular to the longitudinal direction of the running carriage 14. The rolling bodies 15a are rotationally supported about a horizontally extending rotational axis in a second running plane, and the rolling bodies 15c are rotationally supported about a horizontally extending rotational axis in a third running plane. The first, second and third running plane can be mutually spaced from one another in a height direction, whereby the lateral stability of the running carriage 14 can be increased.

On both end regions of the running carriage 14, a damping element 19a, 19b is provided, preferably in the form of an elastically bendable spring tongue. By the damping elements 19a, 19b, a movement of the running carriage 14 can be dampened when the running carriage 14 abuts against a front end stop and a rear end stop of the drawer pull-out guide 4 for limiting a displacement path of the running carriage 14.

The running carriage 14, besides the load-transmitting rolling bodies 15a, 15b, 15c, 15d, includes at least two rollers 16a, 16b rotationally supported about a, preferably substantially vertically extending, rotational axis (Y) orientated in a second direction. The first roller 16a has a larger diameter than the second roller 16b, and the first roller 16a bears without clearance against the running limb 17a of the first guide rail 9 as well as without clearance against the second running limb 17b of the second guide rail 11. On the contrary, the second roller 16b is guided with a clearance to the first running limb 17a of the first guide rail 9 and/or with a clearance to the second running limb 17b of the second guide rail 11.

The running carriage 14 shown in FIG. 3a has the advantage that the running carriage 14, without structural modifications, can be used for a drawer pull-out guide 4 to be arranged on a first (right-handed) side of the drawer 3 as well for a drawer pull-out guide 4 to be arranged on a second (left-handed) side of the drawer 3, without the need that the running carriage 14 has to be constructed in a mirror-symmetrical manner. Accordingly, the running carriage 14 is simply rotated by 180° when applied to the second drawer pull-out guide 4, whereby the first roller 16a having the larger diameter of the first drawer pull-out guide 4 is arranged in a rear-end region of the running carriage 4, and the other first roller 16a having the larger diameter of the second drawer pull-out guide 4 is arranged in a front-end region of the running carriage 4.

FIG. 3b shows the encircled region of FIG. 3a in an enlarged view. In the shown embodiment, the first roller 16a is configured as a two-component roller and includes an inner core 20 and an outer shell 21 separate from the core 20. The inner core 20 and the outer shell 21 can be formed by a different material or by different types of plastic. It can be preferably provided that the first roller 16a and/or the second roller 16b are formed by a different material, and/or that the first roller 16a is formed by a softer material than the second roller 16b. Further, it can be provided that the first roller 16a is formed by an elastic material, preferably silicone material, whereby the first roller 16a can bear without clearance against the running limbs 17a, 17b of the guide rails 9, 10, 11 so as to provide for a correct position of the running carriage 14 in relation to the guide rails 9, 10, 11.

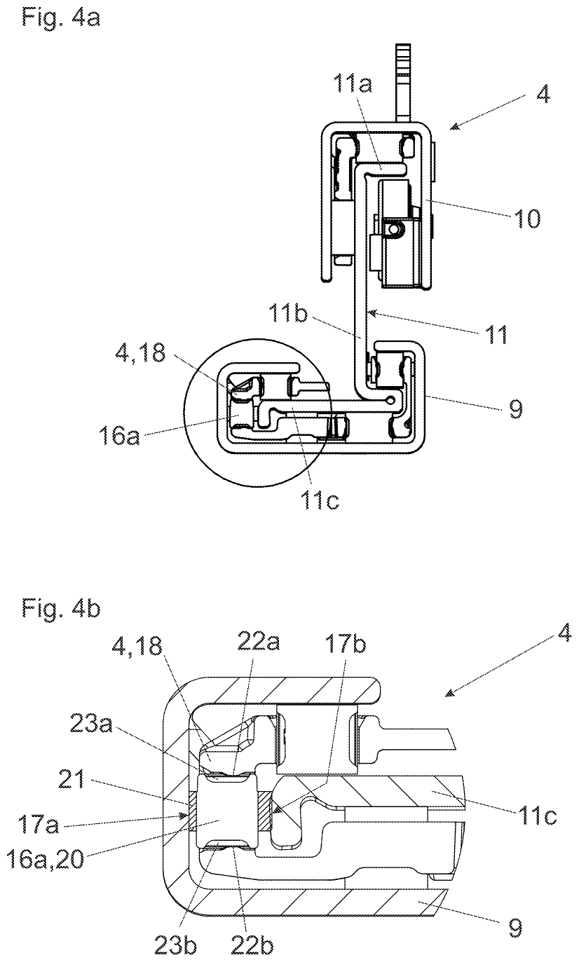

FIG. 4a shows the drawer pull-out guide 4 with the guide rails 9, 10, 11 in a cross-sectional view. It can be seen that the lower transverse limb 11c of the third guide rail 11 is at least partially, preferably substantially entirely, received within the C-shaped profile of the first guide rail 9.

FIG. 4b shows the encircled region of FIG. 4a in an enlarge view. It can be seen that the first roller 16a of the running carriage 14 bears without clearance to both the running limb 17a of the first guide rail 9 and the running limb 17b of the third guide rail 11. In the shown embodiment, the first roller 16a is formed by the core 20 and by the shell 21, the shell 21 bearing without clearance against the running limbs 17a, 17b.

The rolling bodies 15a, 15b, 15c, 15d and/or the rollers 16a, 16b are rotationally supported and held on the base body 18 of the running carriage 14 via a recess 23a, 23b and via at least one protrusion 22a, 22b engaging into the recess 23a, 23b. It can be preferably provided that the recess 23a, 23b is arranged on the rolling bodies 15a, 15b, 15c, 15d and/or on the rollers 16a, 16b, and the protrusion 22a, 22b is arranged on the base body 18 of the running carriage 14. In a mechanical reversal it is, of course, also possible that the recesses 23a, 23b can be arranged on the base body 18 of the running carriage 14 and the protrusions 22a, 22b can be arranged on the rolling bodies 15a, 15b, 15c, 15d and/or on the rollers 16a, 16b.

In contrast to the shown figures, it can be provided that the running carriage 14 having the larger first roller 16a is not only displaceably supported between the first guide rail 9 and the third guide rail 11, but can be also be displaceably supported between the third guide rail 11 and the second guide rail 10.

1. A running carriage for a drawer pull-out guide, the running carriage comprising:
a base body;
a plurality of load-transmitting rolling bodies arranged in or on the base body, the load-transmitting rolling bodies being rotationally supported on the base body about a rotational axis orientated in a first direction;
a first roller; and
at least one second roller rotationally supported on the base body about a rotational axis orientated in a second direction, the rotational axis oriented in the second direction extending transversely to the rotational axis orientated in the first direction,
wherein the first roller has a larger diameter than the second roller.

2. The running carriage according to claim 1, wherein rotational axis orientated in the first direction, in a mounting position of the running carriage, extends substantially horizontally, and/or that the rotational axis orientated in the second direction, in a mounting position of the running carriage, extends substantially vertically.

3. The running carriage according to claim 1, wherein the first roller and the second roller are made of a different material.

4. The running carriage according to claim 1, wherein the first roller is formed by a softer material than the second roller.

5. The running carriage according to claim 1, wherein the first roller is configured as a two-component roller.

6. The running carriage according to claim 1, wherein the first roller includes an inner core and an outer shell separate from the core, wherein it is preferably provided that the core and the shell are formed by a different material or by different types of plastic.

7. The running carriage according to claim 1, wherein the first roller includes silicone material.

8. The running carriage according to claim 1, wherein the rolling bodies and/or the rollers are rotationally supported and held on the base body of the running carriage via a recess and via at least one protrusion engaging the recess, wherein it is preferably provided that the recess is arranged on the rolling bodies and the at least one protrusion is arranged on the base body of the running carriage.

9. The running carriage according to claim 1, wherein the rolling bodies and/or the first roller and/or the second roller has or have a cylindrical form.

10. A drawer pull-out guide comprising a first guide rail which is preferably configured to be fixed to a furniture carcass, at least one further guide rail displaceably supported relative to the first guide rail, and the running carriage according to claim 1, wherein the running carriage is displaceably supported between the first guide rail and the further guide rail.

11. The drawer pull-out guide according to claim 10, wherein the first guide rail includes at least one first running limb along which the running carriage is displaceably supported, wherein the first roller of the running carriage has a larger diameter than the second roller of the running carriage, wherein the first roller bears without clearance against the first running limb of the first guide rail and that the second roller is guided with a clearance to the first running limb of the first guide rail.

12. The drawer pull-out guide according to claim 11, wherein the first roller bears without clearance against the first running limb of the first guide rail as well as against a second running limb of the further guide rail, and/or wherein the second roller is guided with a clearance to the first running limb of the first guide rail as well as with a clearance to the second running limb of the further guide rail.

13. The drawer pull-out guide according to claim 12, wherein the first running limb of the first guide rail and the second guide rail of the further guide rail extend substantially parallel to one another.

14. An arrangement comprising a first drawer pull-out guide and a second drawer pull-out guide, each of the first drawer pull-out guide and the second drawer pull-out guide being configured according to claim 10, wherein the first drawer pull-out guide is configured to be arranged on a first side of a drawer and the second drawer pull-out guide is configured to be arranged on a second side of the drawer, wherein the first drawer pull-out guide includes a first running carriage and the second drawer pull-out guide includes a second running carriage, wherein each of the first running carriage and the second running carriage includes at least two rollers having a different diameter, wherein the roller having the larger diameter of the first running carriage is arranged in a rear-end region of the first running carriage, and the roller having the larger diameter of the second running carriage is arranged in a front-end region of the second running carriage.

15. A drawer comprising the arrangement according to claim 14.
